(19) United States
(12) Patent Application Publication
(10) Pub. No.: US 2011/0185665 A1
(43) Pub. Date: Aug. 4, 2011

(54) POLYMERIC BUILDING PRODUCT AND METHOD OF MAKING

(75) Inventors: Clyde Allen, Columbiaville, MI (US); Timothy Roush, Flint, MI (US); Barton Gentsch, Lapeer, MI (US); Chad Westenfeld, Metamora, MI (US)

(73) Assignee: TAPCO INTERNATIONAL CORPORATION, Wixom, MI (US)

(21) Appl. No.: 13/016,039

(22) Filed: Jan. 28, 2011

Related U.S. Application Data
(60) Provisional application No. 61/299,599, filed on Jan. 29, 2010.

(51) Int. Cl. E04F 13/08; C09D 5/29; B29C 45/16; E04B 1/00; E04D 1/00

(52) U.S. Cl. 52/311.1; 523/171; 264/73

(57) ABSTRACT

A method of forming a polymeric building product having a color variation simulating natural building material includes introducing base color pellets having a base color into the barrel and providing a plurality of first colorant shots and second colorant shots. The first and second colorant shots are repeatedly introduced to the base color pellets in an alternating pattern. By repeatedly introducing at least one first colorant shot and at least one second colorant shot to the base color pellets in an alternating pattern, the barrel is in a constant state of purging. As one melted colorant shot is purged and replaced by another melted colorant shot, the melted composition includes streaks in the shape of swirls, wisps, etc., which advantageously creates color variations that simulate natural building material.

### CROSS-REFERENCE TO RELATED APPLICATIONS

The subject patent application claims priority to and all the benefits of U.S. Provisional Patent Application Ser. No. 61/299,599, which was filed on Jan. 29, 2010, the entire specification of which is expressly incorporated herein by reference.

### BACKGROUND OF THE INVENTION

1. Field of the Invention

The present invention relates to a building product formed of a polymer and simulating the appearance of natural building material. The present invention also includes a method of making the polymeric building product.

2. Description of the Related Art

Natural material such as wood shake is known to be used a building product cover a substrate of a building, such as a roof and/or a wall. The wood shake provides the function of covering and protecting the roof and/or wall of the building. In addition, the wood shake has an aesthetically appealing appearance.

Wood shake is traditionally formed from wood such as cedar. Wood shake is relatively expensive to produce because it requires harvesting and splitting of wood, which is time consuming, labor intensive, and results in excess unused wood that is not suitable for shake.

In addition, wood shake is relatively expensive and labor intensive to install. Several individual pieces of wood shake are first mounted to the substrate in a row. Care is taken to space each of the wood shake from each to accommodate for expansion and retraction of the wood shake due to atmospheric changes. A layer of felt is then mounted to the substrate overlapping a portion of the row of wood shake. Then a second row of wood shake is mounted to the substrate overlapping the felt such that the felt interleaves the two rows of shake. This configuration is repeated such that several rows of wood shake interleaved with felt cover the substrate.

With wood shake, the interleaved felt is intended to prevent wind and blowing precipitation from blowing between adjacent pieces of wood shake and below overlapping pieces of wood shake. As such, the felt reduces water logging of the wood shake and water intrusion to the substrate and acts as an insulator. However, as stated above, the material and installation associated with the interleaved felt is relatively expensive and labor intensive.

In addition, attempts to produce polymeric building products to have an appearance that simulates the look of natural material have been unsuccessful. In particular, the texture, and more importantly, the color of the polymeric building product are unrealistic.

Accordingly, there remains an opportunity to develop a building product that has a color variation that simulates natural material and a method of making the same while eliminating the disadvantages highlighted above.

### SUMMARY OF THE INVENTION AND ADVANTAGES

The present invention also includes a method of forming a polymeric building product having a color variation simulating a natural building material with the use of a machine having a barrel for melting resin pellets, a screw for moving the resin pellets in the barrel, and a throat leading to the barrel for feeding pellets to the barrel. The method comprises introducing base color pellets having a base color into the barrel. The method also comprises providing a plurality of first colorant shots each including first color pellets having a first color and providing a plurality of second colorant shots each including second color pellets having a second color, the base color, the first color, and the second color being different. The method also comprises repeatedly introducing at least one first colorant shot and at least one second colorant shot to the base color pellets in an alternating pattern.

The method of the present invention advantageously forms a polymeric building product that has a color variation that simulates natural building material. By repeatedly introducing at least one first colorant shot and at least one second colorant shot to the base color pellets in an alternating pattern, the barrel is in a constant state of purging. In other words, as the melted colorant shot of one of the first and second colors is purged from the barrel, a melted colorant shot of the other of the first and second colors follows. The melted colorant is purged in that the remnants are moved out of the barrel and replaced by the other color. Likewise, as that next colorant shot is purged from the barrel, another melted colorant shot follows. As one melted colorant shot is purged and replaced by another melted colorant shot, the melted composition includes streaks in the shape of swirls, wisps, etc., which advantageously creates color variations that simulate natural building material. In addition, each building product formed with the method has a unique color variation due to the constant state of purging. This unique color variation gives each building product a distinctive characteristic, which replicates natural materials.

The present invention includes a polymeric building product simulating a natural building material for attachment to a substrate of a building next to an adjacent building product and partially below an overlying building product. The polymeric building product comprises an upper edge and a lower edge spaced from each other along an axis. The polymeric building product also comprises a top surface for facing outwardly from the substrate and a bottom surface for facing toward the substrate. A first side and a second side are spaced from each other and each extends between the upper edge and the lower edge. At least one first side tab extends from the first side and at least one second side tab extends from the second side for disposition adjacent the first side tab of the adjacent building product below the overlying building product to form a gap between the second side, the adjacent building product, the substrate, and the overlying building product. At least one of the one first side tab and the one second side tab extends from the bottom surface substantially to the top surface for plugging the gap to prevent wind and blowing precipitation from blowing in the gap.

By extending from the bottom surface substantially to the top surface, the at least one of the first side tab and the one second side tabs extend from the substrate substantially to the overlying building product when attached to the substrate. As such, the at least one of the first side tab and the one second side tab extend along a sufficient portion of the thickness of the building material to adequately plug the gap against wind and blowing precipitation intrusion, which advantageously prevents water damage and increases the useful life of the substrate. In addition, the plugging of the gap by the at least one of the first side tab and the one second side tab reduces or eliminates the use of additional materials necessary to protect the substrate. This reduction or elimination of additional materials reduces the material and labor costs of attaching the building product to the substrate.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a portion a building including a plurality of polymeric building products attached to a substrate;

FIG. 2 is a perspective view of the polymeric building product including a color variation simulating natural building material;

FIG. 3 is a perspective view of two polymeric building products engaging each other in a non-offset position;

FIG. 4 is a perspective view of two polymeric building products engaging each other in an offset position;

FIG. 5 is a perspective view of a portion of two polymeric building products exploded away from each other;

FIG. 6 is a bottom view of two polymeric building products engaging each other;

FIG. 7 is a side view of a polymeric building product attached to the substrate of the building;

FIG. 8 is perspective view of a portion of a first embodiment of a machine for making the polymeric building material;

FIG. 9 is another perspective view of a portion of the machine of FIG. 8;

FIG. 10 is perspective view of a portion of a second embodiment of the machine for making the polymeric building material; and

FIG. 11 is a perspective view of the portion of the machine of FIG. 10.

### DETAILED DESCRIPTION OF THE INVENTION

Referring to the Figures, wherein like numerals indicate like parts throughout the several views, a polymeric building product 10 simulating natural building material is generally shown at 10. The building product 10 shown in the figures is a roof shingle that simulates the appearance of a cedar shake shingle. Alternatively, the building product 10 can be a any type of product such as, for example, shingles, siding, trim, etc., that simulates the appearance of any other natural building material such as, for example, wood, stone, brick, marble, ceramic, clay, slate, brick, metal, concrete, etc.

The building product 10 is formed of a polymer, as set forth further below. As also set forth below, the building product 10 can be formed by, for example, injection molding. However, it should be appreciated that the building product 10 can be formed by any technique without departing from the nature of the present invention.

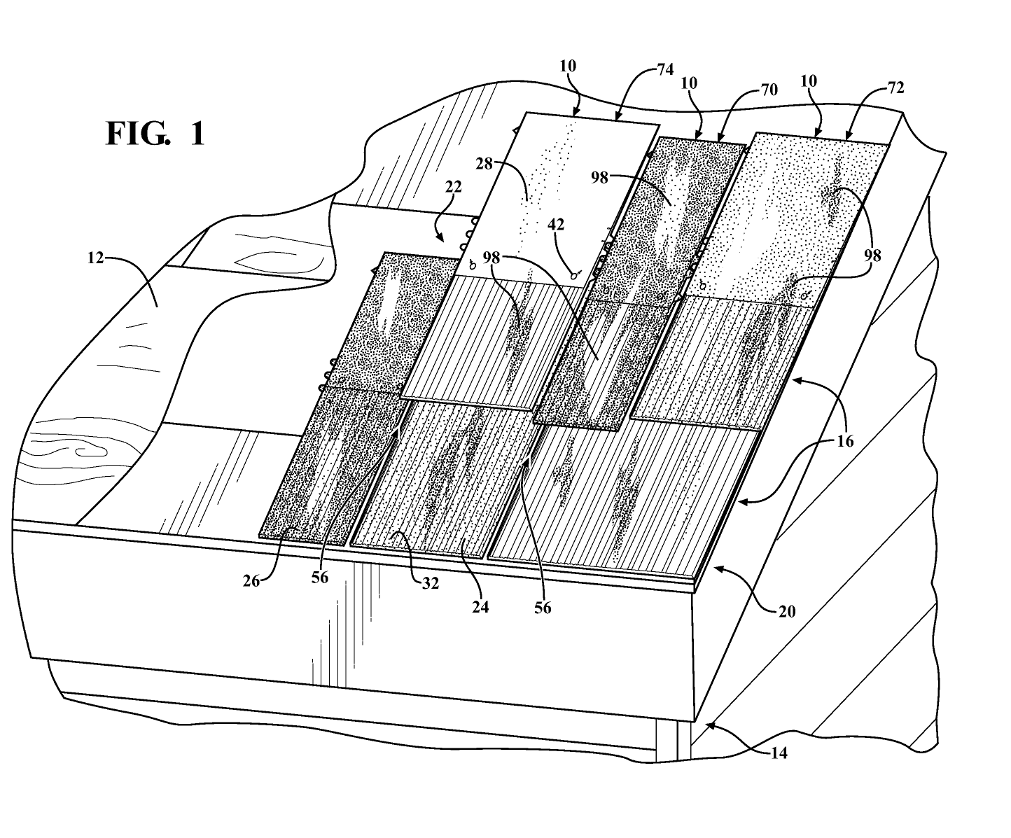

With reference to FIG. 1, the building product 10 is attached to a substrate 12 of a building 14. For example, the building product 10 is shown in FIG. 1 as being attached to a roof of a building 14. Alternatively, the building product 10 can be mounted to a wall of the building 14. The building 14 can be of any type such as, for example, a residential or commercial building 14.

With continued reference to FIG. 1, a plurality building products 10 can be mounted to the substrate 12 in overlapping rows 16 to define a polymeric covering system 18. FIG. 1 is numbered to show an exemplary first row 20 and second row 22. For exemplary purposes, FIG. 1 is numbered to identify one example of a first building product 24, an adjacent building product 26, and an overlying building product 28 overlying a portion of the first building product 24 and the adjacent building product 26.

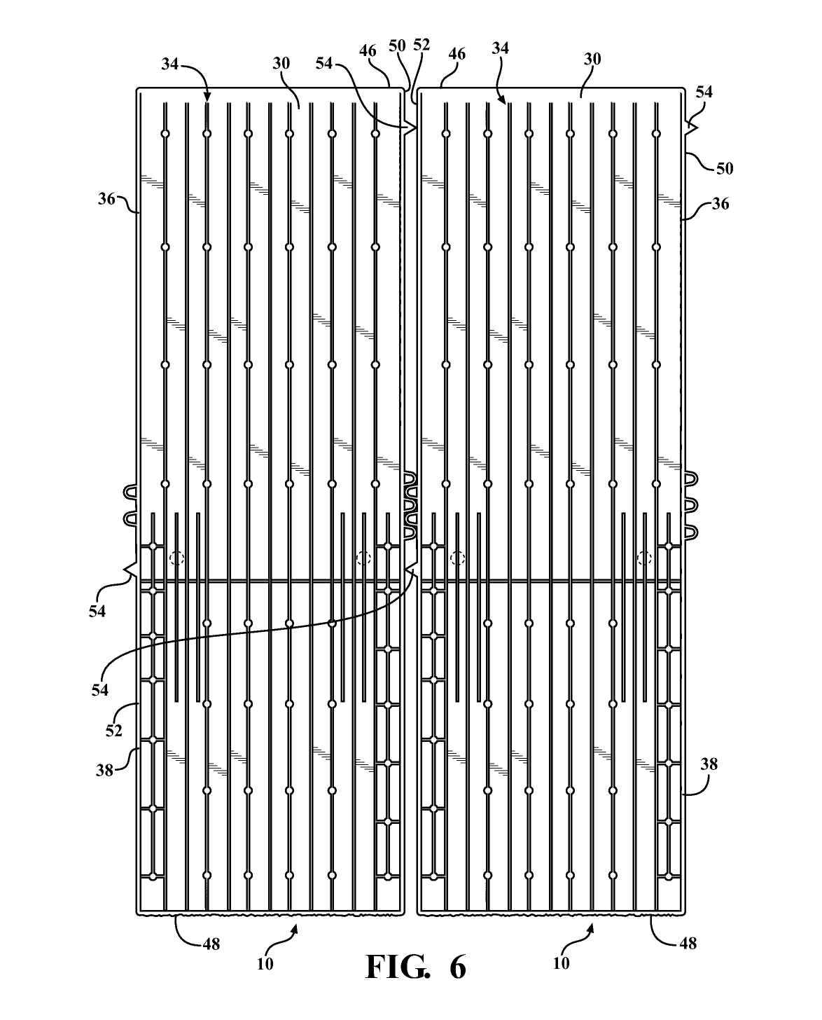

The building product 10 has a bottom surface 30 that faces toward the substrate 12 when mounted to the substrate 12, i.e., faces downwardly. When mounted to the substrate 12, a top surface 32 of the building product 10 faces away from the substrate 12, i.e., faces upwardly. The bottom surface 30 is typically not visible when the building product 10 is mounted to the substrate 12. The bottom surface 30 can, for example, define reinforcement ribs 34 to increase the rigidity of the building product 10, as shown in FIG. 6.

The top surface 32 has an upper portion 36 and a lower portion 38. When the building product 10 is mounted to the substrate 12, the upper portion 36 is disposed above the lower portion 38. For example, when mounted to a roof, the building product 10 is oriented such that the upper portion 36 is disposed above the lower portion 38 and the building product 10 slopes downwardly from the upper portion 36 to the lower portion 38. As another example not shown in the Figures, when mounted to a wall of the building 14, the upper portion 36 is disposed above the lower portion 38 and the lower portion 38 extends downwardly from the upper portion 36.

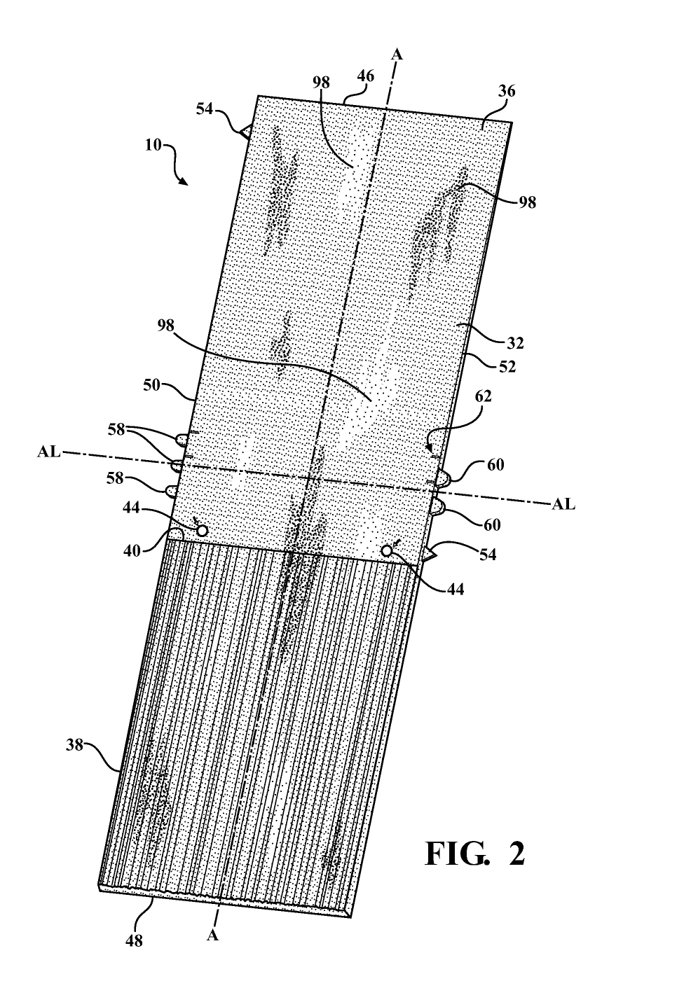

With reference to FIGS. 2-4, the lower portion 38 is typically textured to resemble natural material. The upper portion 36 is covered by another building product 10, as set forth further below, so the upper portion 36 can have the same or a different texture than the lower portion 38 without negatively affecting the appearance of the polymeric covering system. Typically, the upper portion 36 is flat to minimize gaps 56 between overlapping building product 10 to minimize water intrusion, insect infestation, etc.

With reference again to FIG. 1, when the plurality of building products 10 are arranged in the rows 16, the upper portion 36 of each building product 10 is adjacent the upper portion 36 of adjacent building products 10 and the lower portion 38 of each building product 10 is adjacent the lower portion 38 of adjacent building products 10. In other words, the building products 10 are typically aligned on the substrate 12 side-by-side and in the same general orientation. As set forth below, adjacent building products 10 can slightly offset from each other in a direction along the axis A.

Typically, the first row 20 is mounted to the substrate 12 and a second row 22 mounted to the substrate 12 with the lower portions 38 of the building products 10 of the second row 22 overhanging the upper portion 36 of the building products 10 of the first row 20. The lower portions 38 of the building products 10 of the second row 22 can extend from the upper portion 36 of the building products 10 of the first row 20 to slightly overhang an upper portion 36 of the lower portion 38 of the building products 10 of the first row 20. Alternatively, the lower portion 38 of the building products 10 of the second row 22 can terminate at an intersection of the upper 36 and lower 38 portion of the building products 10 of the first row 20. In any event, the upper portion 36 is concealed by overlapping building products 10 and at least part of the lower portion 38 is exposed.

The upper portion 36 can have a different texture or no texture relative to the lower portion 38, as set forth above, and/or the building product 10 can define a parting line 40 separating the upper portion 36 and the lower portion 38 to aid in the proper overlap during installation of the building products 10 on the substrate 12. In other words, the installer can ensure proper overlap of the second row 22 over the first row 20 by visually confirming that the building products 10 of the second row 22 terminate at or overhang the different texture and/or parting line 40.

When mounted to a roof, for example, the first row 20 of building products 10 is mounted on a front edge of the roof, e.g., the eave. The first row 20 typically overhangs the front edge slightly. The second row 22 is then mounted to the roof such that the lower portions 38 of the building products 10 of the second row 22 overhang the upper portions 36 of the building products 10 of the first row 20 as set forth above. Additional rows 16 of building products 10 are subsequently added in the same fashion until the substrate 12 is covered with rows 16 of building products 10. Typically, a cap (not shown), such as a ridge cap in the case of a roof, is placed over a top row of building products 10 to cover the upper portions 36 of the top row of building products 10.

The building product 10 can be mounted to the substrate 12 with fasteners 42. For example, the building product 10 can define one or more holes or divots 44 in the building product 10 such that a nail or other suitable fastener can be inserted into the divot 44 and driven into the substrate 12 to mount the building product 10 to the substrate 12. The divot 44 is typically defined in the upper portion 36 such that the divot 44 and the fastener 42 are concealed by an overlapping building product 10. Alternatively, or in addition, adhesives can be used to mount the building product 10 onto the substrate 12.

The building product 10 includes an upper edge 46 and a lower edge 48 spaced from each other along an axis A and a first side 50 and a second side 52 spaced from each other and extending between the upper edge 46 and the lower edge 48. The upper edge 46 bounds the upper portion 36 opposite the lower portion 38 and the lower edge 48 bounds the lower portion 38 opposite the upper portion 36. Both the upper portion 36 and the lower portion 38 extend from the first side 50 to the second side 52. The upper edge 46, lower edge 48, first side 50, and second side 52 typically define a rectangular shape. The rectangular shape can be oblong, as shown in the Figures, or can be square. Alternatively, the building product 10 can have less than four edges, i.e. triangular, or can have more than four edges without departing from the nature of the present invention.

At least one spacer 54 extends from at least one of the first side 50 and the second side 52. When building products 10 are mounted to the substrate 12 in the rows 16, the spacer 54 separates adjacent building products 10 to properly space and align adjacent building products 10 to simulate natural material, such as wood shake. The spacer 54 defines a gap 56 between the building product 10, the adjacent building product 10, the substrate 12, and the overlying building product 28.

Typically at least two spacers 54 extend between adjacent building products 10 to ensure generally parallel alignment of the building products 10, as shown in FIG. 1. In such an embodiment, the spacers 54 can be triangular in shape such that a point of the triangle abuts an adjacent building product 10 to aid in parallel alignment. However, it should be appreciated that the spacer 54 can be any shape without departing from the nature of the present invention. The spacer 54 typically extends from the upper portion 36 of the building product 10 such that the spacer 54 is overlapped by another building product 10 that overlaps the upper portion 36.

With reference to FIGS. 1-5, the building product 10 includes a plurality of tabs 58, 60 extending from the first side 50 and the second side 52 for interlocking with adjacent building products 10. Specifically, the building product 10 has at least one first side tab 58 extending from the first side 50 and at least one second side tab 60 extending from the second side 52. As shown in the Figures, the at least one second side tab 60 includes two second side tabs 60 are spaced from each other in a direction along the axis A for receiving a first side tab 58 of the adjacent building product 10 below the overlying building product 10. For example, as shown in the Figures, the at least one first side tab 58 is further defined as three first side tabs 58 extending from the first side 50 and spaced from each other along the axis A.

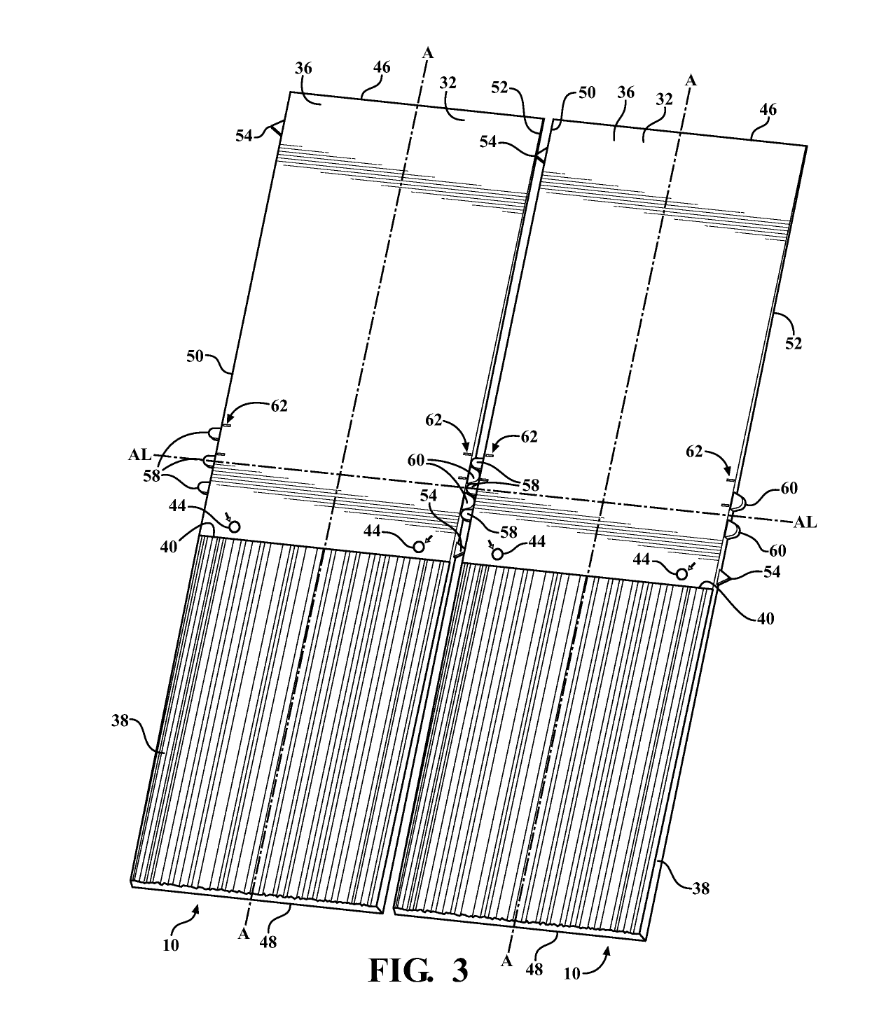

One of the first side tabs 58 is typically aligned relative to the axis A between two second side tabs 60 for fitting between two second side tabs 60 of another adjacent building product 10. For example, as shown in FIG. 3, a lateral axis AL through one of the first side tabs 58 indicates that the first side tab 58 is aligned relative to the axis A between two second side tabs 60. For example, when the first side tab 58 of the first building product 10 is disposed between two second side tabs 60 of the adjacent building product 10, the lower edge 48 of the first building product 24 aligns with the lower edge 48 of the adjacent building product 26, as shown in FIG. 1. Alternatively, either of the other two first side tabs 58 can be disposed between the two second side tabs 60 to offset the adjacent building product 26, as set forth further below.

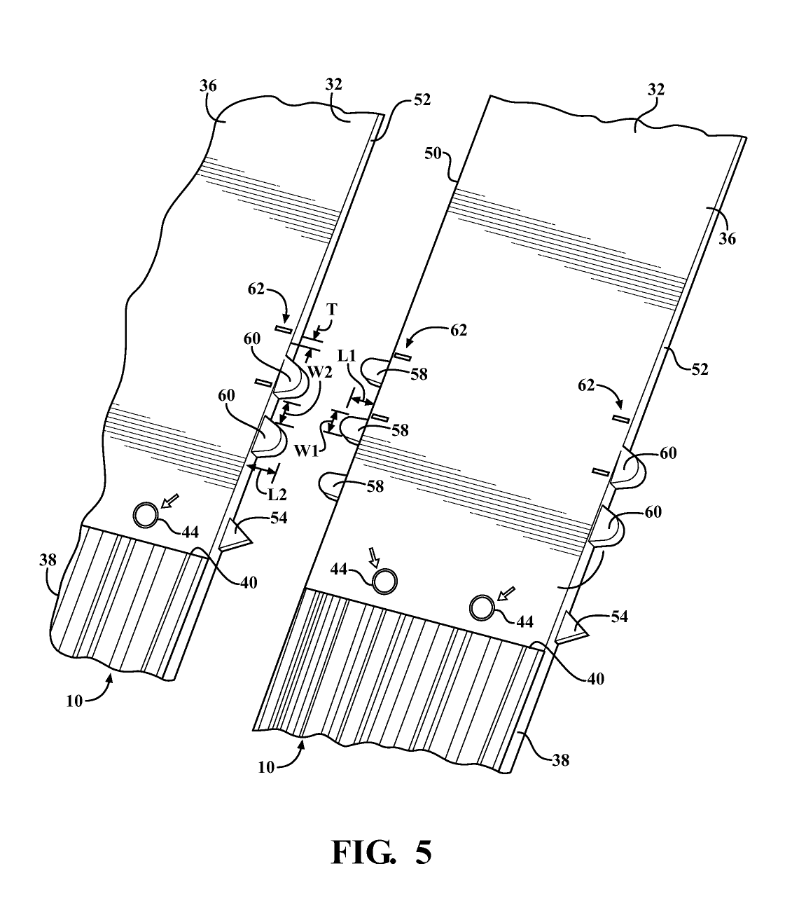

With reference to FIG. 5, two building products 10 are moved toward each other to interlock the tabs 58, 60. Typically, a width W1 of each first side tabs 58 is equivalent to a space W2 between the second side tabs 60 such that tabs 58, 60 of adjacent building products 10 firmly interlock with each other. Typically, a length L1 of the first side tabs 58 is equivalent to or shorter than a length L2 of the second side tabs 60 such that tabs 58, 60 of adjacent building products 10 interlock along the entire length L1, L2 of the tabs 58, 60.

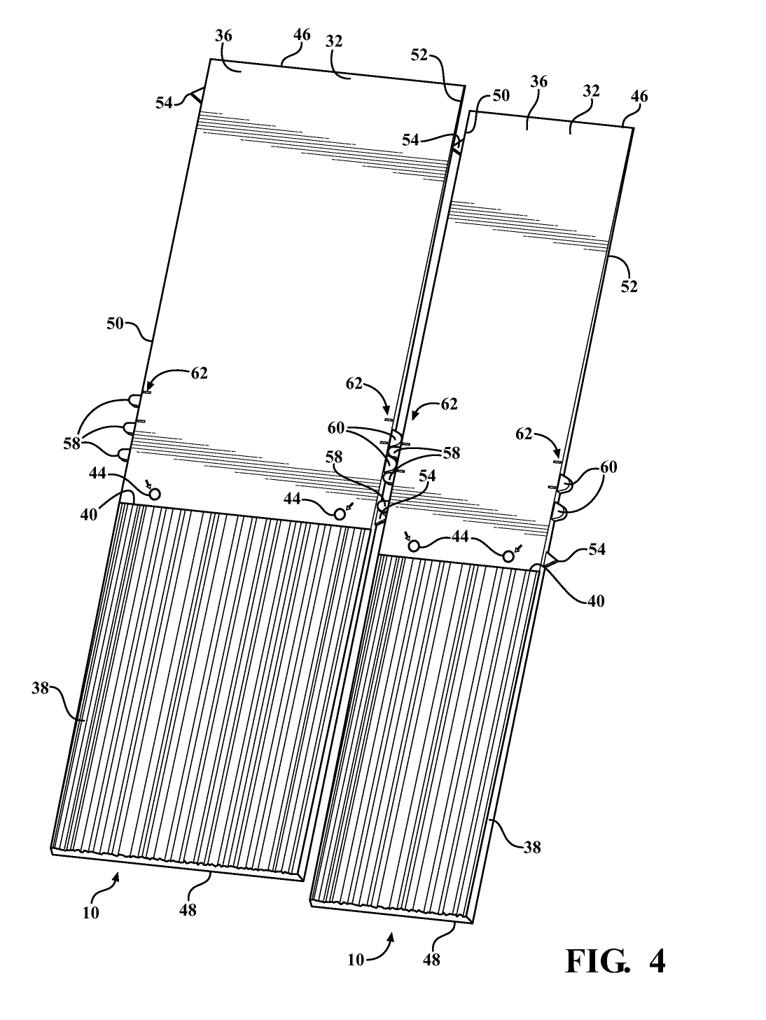

The tabs 58, 60 can be used to selectively align two building products 10 relative to each other. For example, the tabs 58, 60 can be interlocked such that two building products 10 are oriented with no offset, i.e. along a straight line, as shown in FIG. 3. Alternatively, the tabs 58, 60 can be interlocked such that two building products 10 are offset, i.e., the intersections of the upper portions 36 and lower portions 38 of adjacent building products 10 do not form a straight line, as shown in FIGS. 4. As shown in FIGS. 2-4, the top surface 32 can include measuring indicia 62 to indicate relative placement of adjacent building products 10.

At least one of the first side tab 58 and the second side tab 60 extend from the bottom surface 30 substantially to the top surface 32 for plugging the gap 56 to prevent wind and blowing precipitation from blowing in the gap 56. In other words, the at least one tab 58, 60 typically extends along an entire thickness T of the building product 10. Accordingly, when the building products 10 are mounted to the substrate 12 in overlapping rows 16, the tabs 58, 60 extend from the substrate 12 to the overlapping building product 10. In other words, the tabs 58, 60 fill the gap 56 to create a weather baffle to prevent wind and blowing precipitation, e.g., rain and snow, from blowing through the gap 56. It should be appreciated that the tab 58, 60 need not extend along the entire thickness T but instead can extend from the bottom surface 30 substantially to the top surface 32 along a sufficient portion of the thickness T to adequately plug the gap 56 against wind and blowing precipitation intrusion.

Alternatively, instead one tab 58, 60 extending along the entire thickness T of the building product 10, each of the tabs are thinner than the thickness T of the building product 10 and the tabs 58, 60 are staggered relative to each other along the thickness T of the building product 10 to prevent wind and blowing precipitation from blowing through the gap 56. In other words, in such an embodiment, even though no single tab 58, 60 extends along the thickness T, the tabs 58, 60 could be staggered relative to each other to effectively fill the gap 56 along the entire thickness T of the building product 10.

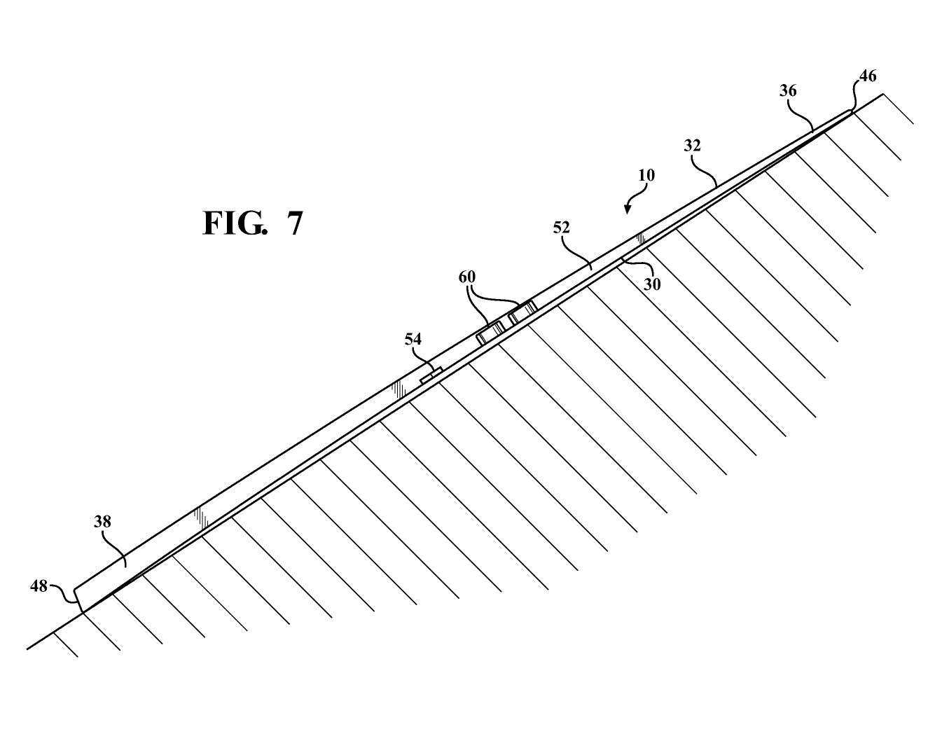

With reference to FIG. 7, the building product 10 is typically manufactured such that the building product 10 curves, and in particular, such that bottom surface 30 is concavely curved and the top surface 32 is convexly curved. For example, the building product 10 can be formed in a mold to have such a curve. Alternatively, or in addition, after being formed the building product 10 can be curved by a secondary process, such as, for example, with a press, a bending brake, or by bending the building product 10 over the knee of an installer.

When mounted to the substrate 12, the building product 10 is typically resiliently flattened to eliminate or severely reduce the concave curvature of the bottom surface 30. The building product 10 is resilient in that it is biased to curve downwardly toward the concave curvature of the bottom surface 30 when mounted to the substrate 12. This resilient bias assists in preventing the building product 10 from curling upwardly, for example, due to exposure to heat and sun. Such an upward curl may compromise the natural material appearance of the building product 10.

As shown in FIGS. 1 and 3, adjacent building products 10 can have varying widths, i.e., a distance from the first side 50 to the second side 52. The varying widths of adjacent building products 10 enhance the simulated appearance of building product 10.

As set forth further below, resin pellets of multiple colors are used to form the polymeric building product 10. The term “resin” is not particularly limited and may include a polymer, plastic, and the like, which may be thermoplastic or thermosetting. The term “pellets” is used herein in a broad sense to include any type of pellets, granules, regrind, powder, particles, grains, spheres, plates, etc., that can be used in the method set forth below. The pellets are not particularly limited and may have any shape and size including any elongation (length/width), convexity (surface roughness), and circularity (perimeter). For example, the pellets can be between 3/32″ and ⅛″ in diameter and can be square, rectangular, spherical, etc. It is contemplated that one or more of these pellet sizes may vary from the values and/or range of values above by ±5%, ±10%, ±15%, ±20%, ±25%, ±30%, etc, and/or be any value or range of values (both whole and fractional) within the aforementioned ranges.

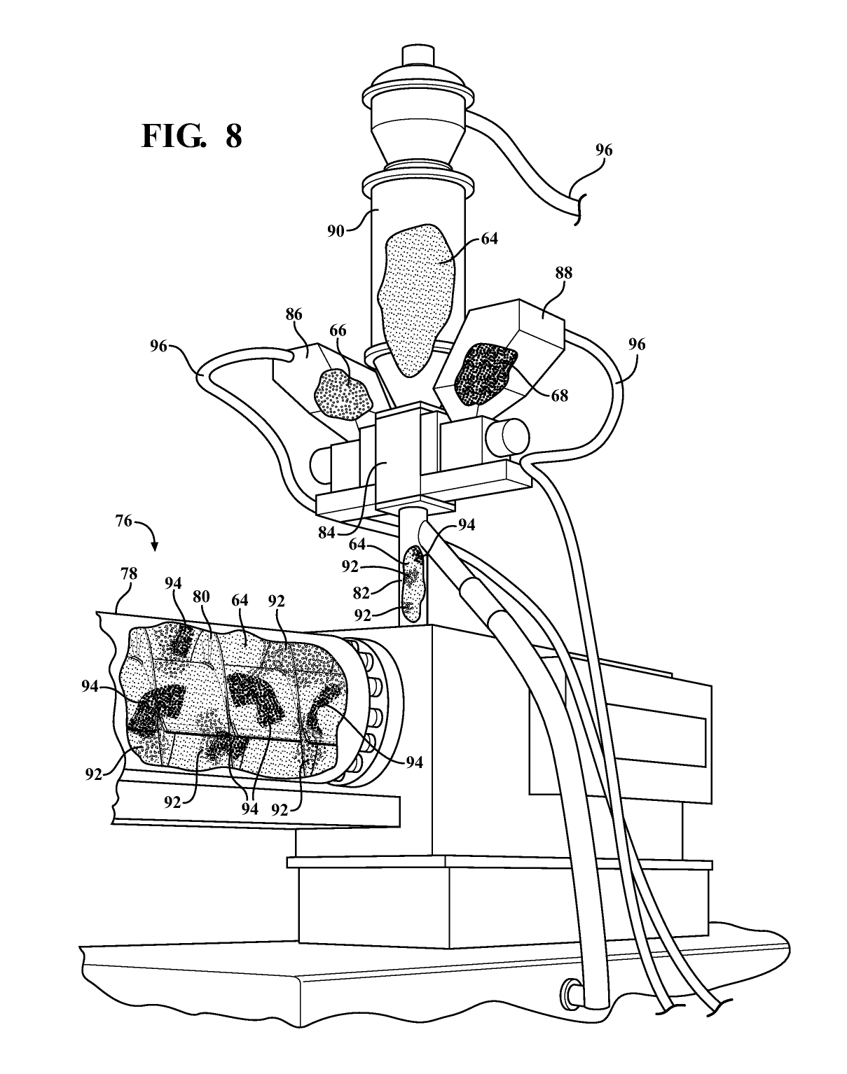

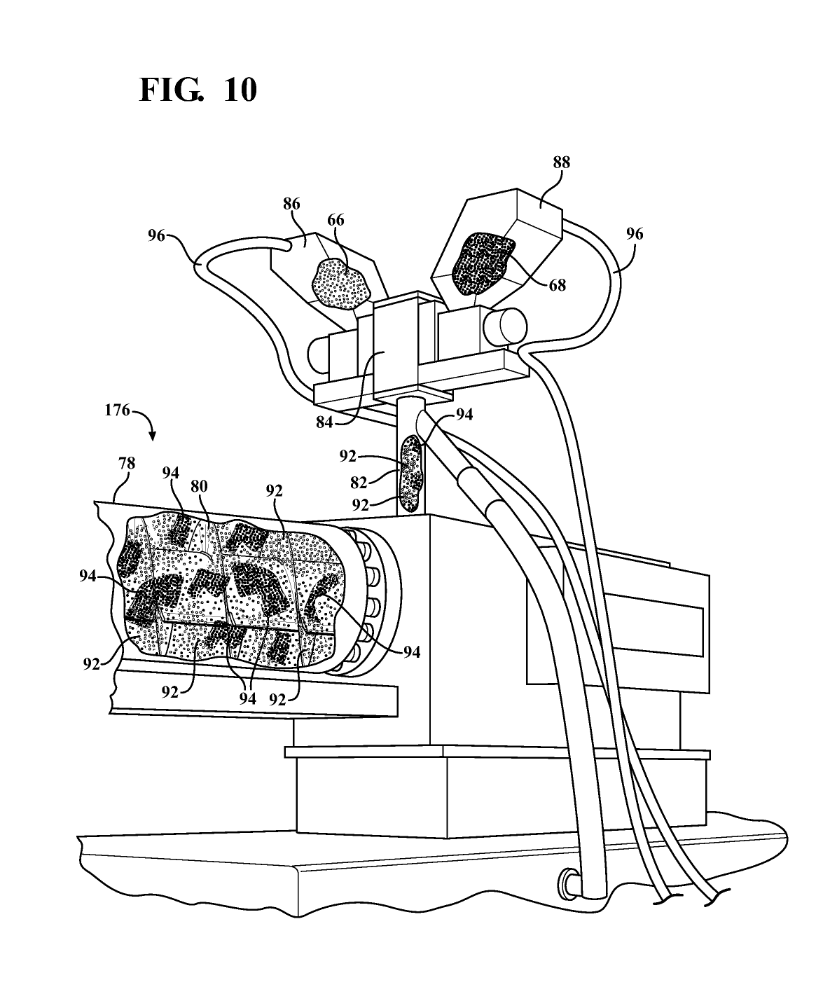

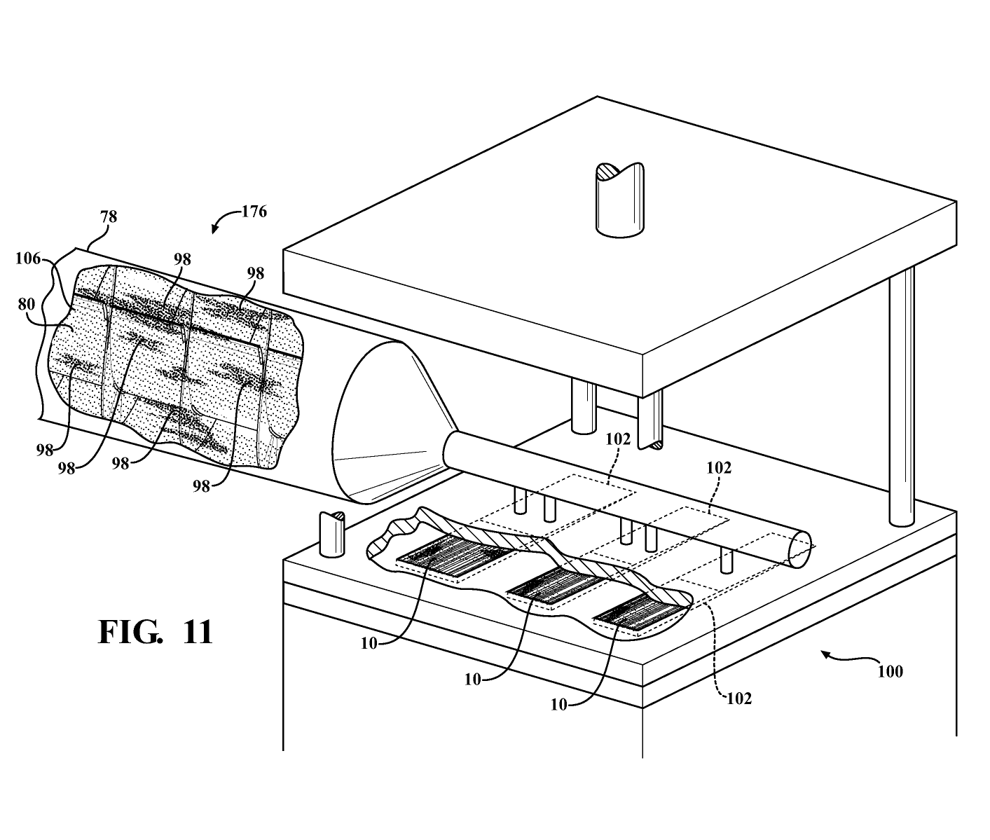

More specifically, in a first embodiment shown in FIG. 8, the resin pellets used to form the polymeric building product 10 include base color pellets 64 including a base polymer and having a base color, first color pellets 66 including a first polymer and having a first color, and second color pellets 68 including a second polymer and having a second color. The base polymer, the first polymer, and the second polymer may be the same or may be different. The base color pellets 64, the first color pellets 66, and the second color pellets 68, independently may include one or more of the base polymer, the first polymer, the second polymer, and combinations thereof. Alternatively, as set forth further below and as shown in FIGS. 10-11, in a second embodiment the resin pellets used to form the polymeric building material include the first color pellets 66 and the second color pellets 68.

The base polymer, first polymer, and second polymer can each independently be, for example, a polyalkylene polymer, such as polypropylene or polyethylene. Non-limiting examples of suitable polyethylene include ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), linear low density polyethylene (LLDPE), low density polyethylene (LDPE), very low density polyethylene (VLDPE), and combinations thereof. Moreover, the base polymer, the first polymer, and/or the second polymer may each independently include a mixture of one of the aforementioned polymers in addition to another polymer, e.g., one or more polymers such as acrylics, silicones, polyurethanes, halogenated plastics, polyester, polyethylene terephthalate, polyvinyl chloride, polystyrene, polyamides, polycarbonate, phenolics, polyetheretherketone, polyetherimide, polylactic acid, polymethylmethacrylate, polytetrafluoroethylene, any one or more of the plastics designated using numerals 1-7 from the Society of the Plastics Industry, and combinations thereof.

One or more of the base polymer, first polymer, and second polymer can be opaque, translucent, or transparent before having the base color, first color, and second color, respectively. In addition, these polymers are not particularly limited in physical properties such as tensile strength, hardness, elongation, density, glass transition temperature, and the like. One or more of the base polymer, the first polymer and the second polymer can be filled (e.g. mineral filled) or unfilled. Non-limiting examples of suitable fillers include magnesium, phosphorus, calcium, and combinations thereof. In addition, one or more of the base polymer, the first polymer, and the second polymer can include one or more additives including, but not limited to, oxidative and thermal stabilizers, impact modifiers, lubricants, release agents, flame-retarding agents, oxidation inhibitors, oxidation scavengers, neutralizers, antiblock agents, dyes, pigments and other coloring agents, ultraviolet light absorbers and stabilizers, organic or inorganic fillers, reinforcing agents, nucleators, plasticizers, waxes, and combinations thereof. Most typically, at least one of the base polymer, the first polymer, and the second polymer is fire resistant, e.g., includes a flame-retarding agent.

The base color, the first color, and the second color may be generated, or formed from/using, any dye or pigment or other colorant known in the art. The base color, the first color, and the second color are different. Typically, the first colorant and the second colorant have at least a 4ΔE spread, and more typically an 8ΔE spread, such that one is relatively dark and one is relatively light. However, in the alternative to being different shades of the same color, the first colorant and the second colorant can have different colors. For example, the base color, the first color, and the second color may be such that the first 70, second 72, and third 74 color variations are various shades of grey with varying grey streaks to simulate wood shake. Alternatively, the base color, the first color, and the second color may create any type of color variation by the method below to achieve a color variation simulating a natural building material such as wood, stone, brick, marble, ceramic, clay, slate, brick, metal, concrete, etc. It should be appreciated that each building product 10 can be generally categorized into one of the first 70, second 72, and third 74 color variations; however, each building product 10 has a slightly different appearance, as set forth below. In other words, even though each building product 10 can be categorized, each building product 10 has a unique appearance caused by streaks 98 that are randomly oriented on the building product 10 and can have varying shades of colors. It should also be appreciated that the color variations 70, 72, 74 are shown with stippling in FIGS. 1 and 2, but is not shown in FIGS. 3-7 merely so that other features can be adequately shown in FIGS. 3-7.

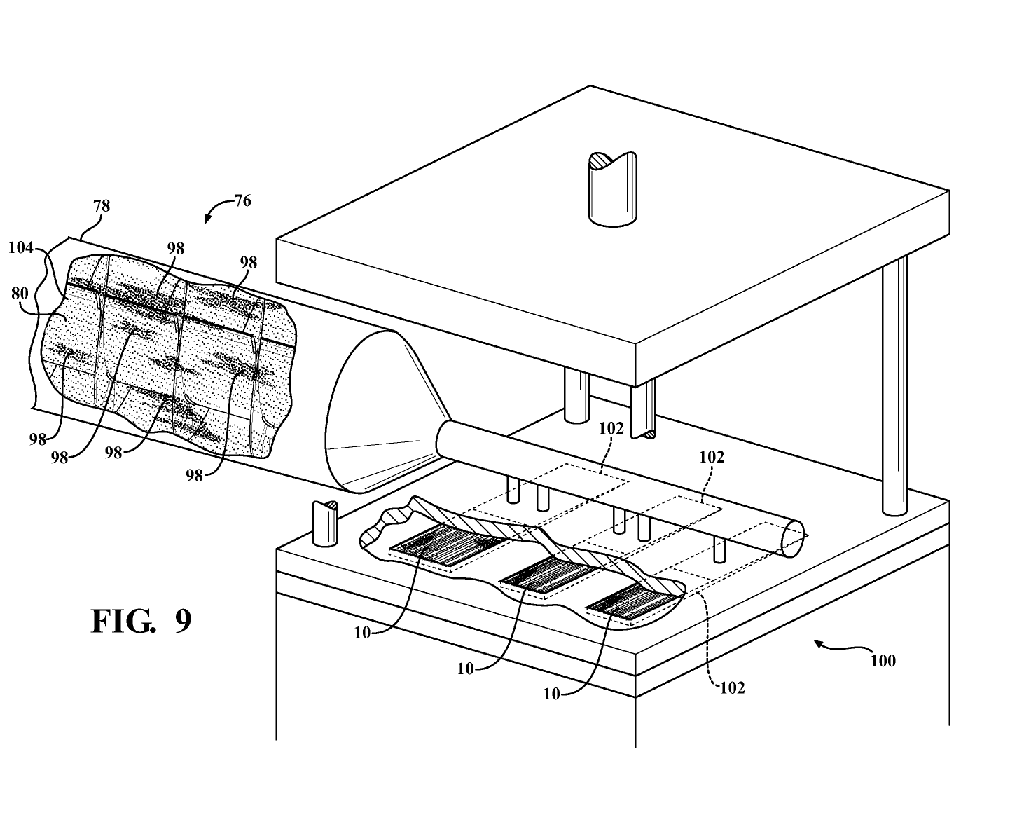

The method of forming the polymeric building product 10 uses a machine 76, 176 to melt the resin pellets 64, 66, 68 into a melted composition 104, 106 and form the melted composition 104, 106 into the polymeric building product 10. A first embodiment of the machine 76 is shown in FIGS. 8 and 9 and a second embodiment of the machine 176 is shown in FIGS. 10 and 11. Common features of the first and second embodiments of the machine 76, 176 are identified with like numerals. The machine 76, 176 is typically a plastic injection molding machine, as set forth further below. However, it should be appreciated that the machine 76, 176 can be any type of machine for forming the pellets into the building product 10 including, but not limited to, plastic extrusion machines, etc., without departing from the nature of the present invention.

With reference to FIGS. 8-11, the machine 76, 176 has a barrel 78 that receives the resin pellets 64, 66, 68 and a screw 80 rotatably disposed in the barrel 78 for moving the resin pellets 64, 66, 68 in the barrel 78. The resin pellets 64, 66, 68 are melted, as set forth further below, by pressure and/or heat as the screw 80 moves the resin pellets 64, 66, 68 through the barrel 78. The screw 80 is typically a reciprocating screw 80 but can alternatively be any type of screw such as, for example, a non-reciprocating extruder screw. The machine 76, 176 can include a ram for moving the melted composition 104 through the barrel 78.

A throat 82 leads to the barrel 78 for feeding the resin pellets 64, 66, 68 to the barrel 78. As set forth further below, a meter 84 is disposed at the barrel 78 for metering the mixture of resin pellets to the throat 82. The meter 84 is typically a gravimetric meter but, alternatively, can be any type of meter without departing from the nature of the present invention. The meter 84 can be of the type that provides a continuous feed or a starvation feed of resin pellets to the screw 80.

With reference to FIGS. 8 and 10, a source of first colorant shots 92, e.g., a first hopper 86, houses the first color pellets 66. A source of the second colorant shots 94, e.g., a second hopper 88, houses the second color pellets 68. With reference to FIG. 8, a source of the base color pellets 64, e.g., a third hopper 90, houses the base color pellets 64.

With reference to FIGS. 8 and 10, the meter 84 is connected to the source of the first colorant shots 92 and the source of the second colorant shots 94. With reference to FIG. 8, the meter 84 is disposed between throat 82 and the first 86, second 88, and third 90 hoppers for combining and feeding the base color pellets 64, first color pellets 66, and the second color pellets 68 to the throat 82. With reference to FIG. 10, the meter 84 is disposed between the throat 82 and the first 86 and second 88 hoppers for combining and feeding the first color pellets 66 and the second color pellets 68 to the throat 82.

With reference to the first embodiment of the method and the first embodiment of the machine 76 shown in FIGS. 8 and 9, the first color pellets 66 and second color pellets 68 are typically introduced to the base color pellets 64 in shots, i.e., first colorant shots 92 and second colorant shots 94, respectively. Specifically, the meter 84 selects a plurality of first color pellets 66 from the first hopper 86 to define one first colorant shot 92 and selects a plurality of second color pellets 68 from the second hopper 88 to define one second colorant shot 94. The meter 84 introduces a plurality first color pellets 66 or second color pellets 68 from the hopper to the base color pellets 64 as a first colorant shot 92 or a second colorant shot 94, respectively.

In the first and second embodiments, the meter 84 determines the size, i.e., the number of pellets, of each of the plurality of shots 92, 94 based on a predetermined setting or, alternatively, determines the size based on an interactive calculation that can be used to adjust the size of each of the plurality of shots 92, 94 as the machine 76 operates. For example, the meter 84 can determine the size of the shots 92, 94 based on recovery time of the screw 80, percentage of first color pellets 66 and second color pellets 68 in relation to the base color pellets 64, weight of the first color pellets 66 and the second color pellets 68, and/or weight of the shot 92, 94. Each colorant shot 92, 94 can be a short burst or can be a continuous introduction to the base color pellets 64. The meter 84 is typically controlled by a programmable logic controller (not shown) that instructs the meter 84 to start and stop the introduction of each shot 92, 94.

The method of forming the building product 10 includes providing a plurality of first colorant shots 92, i.e., a plurality of first color pellets 66 that are later divided into first colorant shots 92 by the meter 84, into the first hopper 86. The method also includes providing a plurality of second colorant shots 94, i.e., a plurality of second color pellets 68 that are later divided into second colorant shots 94 by the meter 84, into the second hopper 88. The pellets 64, 66, 68 can be loaded into the hoppers 86, 88, 90, respectively, by manually feeding the hoppers 86, 88, 90 or by automatically feeding the hoppers 86, 88, 90 with a vacuum system 96 as shown in FIG. 8.

In the first embodiment, the method includes introducing base color pellets 64 into the barrel 78. Specifically, the method includes feeding a flow of base color pellets 64 through the meter 84 to the screw 80 in the barrel 78. The introduction of the base color pellets 64, the first color pellets 66, and the second color pellets 68 from the meter 84 to the screw 80 can be a continuous feed or a starvation feed, as set forth above.

The first embodiment of the method further includes repeatedly introducing at least one first colorant shot 92 and at least one second colorant shot 94 to the flow of base color pellets 64 through the meter 84 in an alternating pattern. In other words, as the flow of base color pellets 64 moves through the meter 84, the meter 84 selectively introduces colorant shots in the alternating pattern.

For example, the alternating pattern includes introducing one first colorant shot 92 followed by another first colorant shot 92 followed by one second colorant shot 94 followed by another second colorant shot 94. As set forth above, this alternating pattern of first colorant shot 92/first colorant shot 92/second colorant shot 94/second colorant shot 94 is repeated for any number of repetitions. As another example, the alternating pattern includes introducing one first colorant shot 92 followed by one second colorant shot 94.

The alternating pattern further comprises spacing the introduction of the at least one first colorant shot 92 and the at least one second colorant shot 94 by a predetermined time. In other words, the introduction of each colorant shot is initiated at different times. Typically, there is no overlap of introduction of a first colorant shot 92 and a second colorant shot 94, i.e., one colorant shot 92, 94 is finished before the other colorant shot 92, 94 begins. However, even though the shots 92, 94 are initiated at different times, some overlap may exist between the shots 92, 94 without departing from the nature of the present invention. This predetermined time separating the shots 92, 94 can be a set value or can be a variable that is calculated by the machine 76.

Repeatedly introducing the colorant shots 92, 94 in the alternating pattern is accomplished by instructing the meter 84 to introduce at least one first colorant shot 92 and at least one second colorant shot 94 to the base color pellets 64 in the alternating pattern. The programmable logic controller, as set forth above, can be programmed to instruct the meter 84 to introduce the colorant shots 92, 94 in the alternating pattern. Since the meter 84 is disposed at the throat 82, the method includes introducing the at least one first colorant shot 92 and the at least one second colorant shot 94 to the base color pellets 64 at the throat 82 of the machine 76 with the meter 84.

With reference to FIG. 9, the first embodiment of the method further includes melting the first color pellets 66 and the second color pellets 68 into the melted composition 104 in the barrel 78. FIG. 8 shows a cut-away view of the barrel 78 in which the pellets 64, 66, 68 are not yet melted. FIG. 9 shows a cut-away view further along barrel 78 in which the pellets 64, 66, 68 are melted and partially mixed together to form the melted composition 104. The pellets 64, 66, 68 are melted by the addition of heat and pressure in the barrel 78. For example, the barrel 78 may be heated to heat the pellets 64, 66, 68 and the screw 80 applies pressure to the pellets 64, 66, 68 as the screw 80 moves the pellets 64, 66, 68 in the barrel 78.

Since the colorant shots 92, 94 are introduced in an alternating pattern, the barrel 78 is in a constant state of purging. In other words, with reference to FIG. 9, as the colorant shot(s) 92 or 94 of one of the first and second colors, now melted, is being purged from the barrel 78, a colorant shot(s) 92 or 94 of other of the first and second colors, now melted, follows Likewise, as that next colorant shot(s) 92 or 94 is purged from the barrel 78, colorant shot(s) 92 or 94 of the original one of the first and second colors, now melted, follows. The melted colorant is purged in that the remnants are forced out of the barrel and replaced by the melted composition 104 having the other color.

As one colorant shot 92 or 94 is purged and replaced by another colorant shot 92 or 94, the melted composition 104 includes streaks 98 in the shape of swirls, wisps, etc. This is a result of the new melted colorant shot 92 or 94 partially mixing with the remnants of the previous melted colorant shot 92 or 94. As a result, the method creates the three color variations 70, 72, 74, as set forth above. The first color variation 70 results from a state where a second colorant shot 94 is being purged from the barrel 78 by a first colorant shot 92. As such the first color variation 70 includes a foundation color defined by a high concentration of the first color and includes streaks 98 having a high concentration of the second color. The second color variation 72 results from a state where a first colorant shot 92 is being purged from the barrel 78 by a second colorant shot 94. As such the second color variation 72 includes a foundation color defined by a high concentration of the second color and includes streaks 98 having a high concentration of the first color. The third color variation 74 results from a state where the first colorant shot 92 and the second colorant shot 94 are mixed together do define an intermediate color. Streaks 98 having a high concentration of the first color and/or the second color are formed on the third color variation 74 by remnants of a first colorant shot 92 and/or a second colorant shot 94 in the barrel 78.

In addition, each building product 10 formed with the method has a unique color variation due to the constant state of purging. This unique color variation gives each building product 10 a distinctive characteristic, which replicates natural materials. In other words, no two building products made from natural materials look exactly alike because each piece of natural material has a unique appearance. The constant state of purging in the present invention forms building products 10 that each has a distinctive appearance to replicate that of natural material.

For example, in a configuration where the base color is conducive to producing a grey product, the first color is dark grey, and the second color is light grey. The method produces a polymeric building product 10 that has various shades of grey with grey streaks of varying shades. Such an embodiment can be designed to simulate weathered wood shake. In such an embodiment, the first color variation 70 is dark grey with medium and/or light grey streaks, the second color variation 72 is light grey with medium and/or dark grey streaks, and the third color variation 74 is medium grey with light and/or dark grey streaks.

With reference to the second embodiment of the method and the second embodiment of the machine 176 shown in FIG. 10, the machine 176 of the second embodiment includes the first hopper 86 and the second hopper 88. In the second embodiment, the first color pellets 66 are typically formed of a colored compound of the first color and the second color pellets 68 are typically formed of a colored compound of the second color. The first color pellets 66 and second color pellets 68 are typically introduced to the throat 82 in first colorant shots 92 and second colorant shots 94, respectively. Specifically, the meter 84 selects a plurality of first color pellets 66 from the first hopper 86 to define one first colorant shot 92 and selects a plurality of second color pellets 68 from the second hopper 88 to define one second colorant shot 94. The meter 84 introduces a plurality first color pellets 66 or second color pellets 68 from the hopper to the throat 82 as a first colorant shot 92 or a second colorant shot 94, respectively.

The second embodiment of the method further includes repeatedly introducing at least one first colorant shot 92 and at least one second colorant shot 94 to the barrel 78 through the meter 84 in an alternating pattern. Repeatedly introducing the colorant shots 92, 94 in the alternating pattern is accomplished by instructing the meter 84 to introduce at least one first colorant shot 92 and at least one second colorant shot 94 to the throat 82 in the alternating pattern. The programmable logic controller, as set forth above, can be programmed to instruct the meter 84 to introduce the colorant shots 92, 94 in the alternating pattern.

FIG. 10 shows a cut-away view of the barrel 78 in which the pellets 66, 68 are not yet melted. FIG. 11 shows a cut-away view further along barrel 78 in which the pellets 66, 68 are melted and partially mixed together to form a melted composition 106. The pellets 66, 68 are melted by the addition of heat and pressure in the barrel 78. For example, the barrel 78 may be heated to heat the pellets 66, 68 and the screw 80 applies pressure to the pellets 66, 68 as the screw 80 moves the pellets 66, 68 in the barrel 78.

Since the colorant shots 92, 94 are introduced in an alternating pattern, the barrel 78 is in a constant state of purging. In other words, with reference to FIG. 11, as the colorant shot(s) 92 or 94 of one of the first and second colors, now melted, is being purged from the barrel 78, a colorant shot(s) 92 or 94 of other of the first and second colors, now melted, follows Likewise, as that next colorant shot(s) 92 or 94 is purged from the barrel 78, colorant shot(s) 92 or 94 of the original one of the first and second colors, now melted, follows.

With continued reference to the second embodiment, as one colorant shot 92 or 94 is purged and replaced by another colorant shot 92 or 94, the melted composition 106 includes streaks 98 in the shape of swirls, wisps, etc. This is a result of the new melted colorant shot 92 or 94 partially mixing with the remnants of the previous melted colorant shot 92 or 94. As a result, the method creates the three color variations 70, 72, 74, as set forth above. The first color variation 70 results from a state where a second colorant shot 94 is being purged from the barrel 78 by a first colorant shot 92. As such the first color variation 70 includes a foundation color defined by a high concentration of the first color and includes streaks 98 having a high concentration of the second color. The second color variation 72 results from a state where a first colorant shot 92 is being purged from the barrel 78 by a second colorant shot 94. As such the second color variation 72 includes a foundation color defined by a high concentration of the second color and includes streaks 98 having a high concentration of the first color. The third color variation 74 results from a state where the first colorant shot 92 and the second colorant shot 94 are mixed together do define an intermediate color. Streaks 98 having a high concentration of the first color and/or the second color are formed on the third color variation 74 by remnants of a first colorant shot 92 and/or a second colorant shot 94 in the barrel 78.

With reference to FIGS. 9 and 11, the method typically includes injection molding the melted material in the injection mold 100. The injection mold 100 includes cavities 102 for forming the melted material into the shape of the polymeric building product 10. The cavities 102 can have varying shape or, alternatively, the cavities 102 can have the same shape as each other. Once in the cavities 102, the melted material is cooled to form the polymeric building product 10. The injection mold 100 can be in any orientation relative to the barrel 78 and the melted composition 104, 106 can be delivered from the barrel 78 to the injection mold 100 by any type of sprue, pipe, etc.

In the first embodiment, the method includes only partially mixing the melted first color pellets 66, the melted second color pellets 68, and the melted base color pellets 64 such that the melted composition 104 has a streaked coloration, as set forth above. As set forth above, the pellets 64, 66, 68 are mixed to a degree; however, the pellets 64, 66, 68 are not completely mixed in the barrel 78 or in the injection mold 100 so as to provide the streaked appearance of the building product 10. The size and the shape of the barrel 78 and the screw 80, the rotation of the screw 80, the material selection of the pellets 64, 66, 68, and shot size and frequency are designed to increase/decrease the mixture of the pellets 64, 66, 68 to achieve the desired appearance of the building product 10.

Similarly, in the second embodiment, the method includes only partially mixing the melted first color pellets 66 and the melted second color pellets 68 such that the melted composition 106 has a streaked coloration, as set forth above. As set forth above, the pellets 66, 68 are mixed to a degree; however, the pellets 66, 68 are not completely mixed in the barrel 78 or in the injection mold 100 so as to provide the streaked appearance of the building product 10. The size and the shape of the barrel 78 and the screw 80, the rotation of the screw 80, the material selection of the pellets 66, 68, and shot size and frequency are designed to increase/decrease the mixture of the pellets 66, 68 to achieve the desired appearance of the building product 10.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A method of forming a polymeric building product having a color variation simulating natural building material with the use of a machine having a barrel for melting resin pellets, a screw for moving the resin pellets in the barrel, and a throat leading to the barrel for feeding pellets to the barrel, the method comprising:
introducing base color pellets having a base color into the barrel;
providing a plurality of first colorant shots each including first color pellets having a first color;
providing a plurality of second colorant shots each including second color pellets having a second color, the base color, the first color, and the second color being different; and
repeatedly introducing at least one first colorant shot and at least one second colorant shot to the base color pellets in an alternating pattern.

2. The method as set forth in claim 1 wherein the machine includes a meter connected to a source of the first colorant shots and a source of the second colorant shots, the method comprising feeding a flow of base color pellets through the meter and instructing the meter to introduce the at least one first colorant shot and the at least one second colorant shot to the base color pellets in the alternating pattern.

3. The method as set forth in claim 1 wherein the alternating pattern includes introducing one first colorant shot followed by another first colorant shot followed by one second colorant shot followed by another second colorant shot.

4. The method as set forth in claim 1 wherein the alternating pattern includes introducing one first colorant shot followed by one second colorant shot.

5. The method as set forth in claim 1 wherein the alternating pattern further comprises spacing the introduction of the at least one first colorant shot and the at least one second colorant shot by a predetermined time.

6. The method as set forth in claim 1 further comprising introducing the at least one first colorant shot and the at least one second colorant shot to the base color pellets at the throat of the machine.

7. The method as set forth in claim 1 further comprising melting the base color pellets, the first color pellets, and the at second color pellets into a melted composition in the barrel.

8. The method as set forth in claim 7 wherein the machine includes an injection mold, the method further comprising injection molding the melted material in the injection mold.

9. The method as set forth in claim 8 further comprising only partially mixing the melted first color pellets, the melted second color pellets, and the melted base color pellets such that the melted composition has a streaked coloration when injection molded into the injection mold.

10. The method as set forth in claim 7 further comprising only partially mixing the melted first color pellets, the melted second color pellets, and the melted base color pellets such that the melted composition has a streaked coloration.

11. A method of forming a polymeric building product having a color variation simulating natural building material with the use of a machine having a barrel for melting resin pellets, a screw for moving the resin pellets in the barrel, a throat leading to the barrel for feeding pellets to the barrel, and a meter disposed between the throat and a source of a plurality of first colorant shots and a source of a plurality of second colorant shots, the method comprising:
introducing base color pellets having a base color into the barrel;
providing the plurality of first colorant shots each including first color pellets having a first color;
providing a plurality of second colorant shots each including second color pellets having a second color, the base color, the first color, and the second color being different;
feeding a flow of base color pellets through the meter and instructing the meter to repeatedly introduce the at least one first colorant shot and the at least one second colorant shot to the base color pellets in an alternating pattern;
melting the base color pellets, the first color pellets, and the second color pellets into a melted composition in the barrel; and
only partially mixing the melted first color pellets, the melted second color pellets, and the melted base color pellets such that the melted composition has a streaked coloration.

12. The method as set forth in claim 11 wherein the alternating pattern includes introducing one first colorant shot followed by another first colorant shot followed by one second colorant shot followed by another second colorant shot.

13. The method as set forth in claim 11 wherein the alternating pattern includes introducing one first colorant shot followed by one second colorant shot.

14. The method as set forth in claim 11 wherein the alternating pattern further comprises spacing the introduction of the at least one first colorant shot and the at least one second colorant shot by a predetermined time.

15. The method as set forth in claim 11 further comprising introducing the at least one first colorant shot and the at least one second colorant shot to the base color pellets at the throat of the machine.

16. The method as set forth in claim 11 wherein the machine includes an injection mold, the method further comprising injection molding the melted material in the injection mold.

17. The method as set forth in claim 16 further comprising only partially mixing the melted first color pellets, the melted second color pellets, and the melted base color pellets such that the melted composition has the streaked coloration when injection molded into the injection mold.

18. A polymeric building product simulating natural building material for attachment to a substrate of a building next to an adjacent building product and partially below an overlying building product, the polymeric building product comprising:
an upper edge and a lower edge spaced from each other along an axis;
a top surface for facing outwardly from the substrate;
a bottom surface for facing toward the substrate;
a first side and a second side spaced from each other and each extending between said upper edge and said lower edge;
at least one first side tab extending from said first side; and
at least one second side tab extending from said second side for disposition adjacent a first side tab of the adjacent building product below the overlying building product to form a gap between the second side, the adjacent building product, the substrate, and the overlying building product;
at least one of said first side tab and said second side tab extending from said bottom surface substantially to said top surface for plugging said gap to prevent wind and blowing precipitation from blowing in said gap.

19. The polymeric building product as set forth in claim 18 wherein said at least one second side tab is further defined as two second side tabs spaced from each other along said axis and wherein the one first side tab is aligned relative to the axis between said two second side tabs for fitting between two second side tabs of another adjacent building product.

20. The polymeric building product as set forth in claim 18 wherein the at least one first side tab is further defined as three first side tabs extending from the first side and spaced from each other along the axis.
